(19) United States
(12) Patent Application Publication
(10) Pub. No.: US 2005/0000699 A1
(43) Pub. Date: Jan. 6, 2005

(54) Horse-shoe-like plate-like hoof pad

(76) Inventor: Karl Rafeld, Wildpoldsried (DE)

Correspondence Address: GIFFORD, KRASS, GROH, SPRINKLE;ANDERSON & CITKOWSKI, PC, 280 N OLD WOODARD AVE, SUITE 400, BIRMINGHAM, MI, 48009, US

(21) Appl. No.: 10/833,390

(22) Filed: Apr. 28, 2004

(30) Foreign Application Priority Data
Apr. 29, 2003 (DE) 203 06 686.3

(51) Int. Cl. A01L 7/02

(52) U.S. Cl. 168/12

(57) ABSTRACT

The invention concerns a horseshoe-like hoof pad of plastic material provided with a lower the underground contacting surface having profile elements. Both legs of the hoof pad can be connected for extending the distance of the legs to the size of the hoof by at least one separate snug fit piece-like connecting bar of plastic material. This connecting bar is engageable with the legs within the area of their ends in order to extend or contract them. The connecting bar which is also named bridge is one layered configured (single bridge) or multiple layered configured (double bridge) and fits with its lateral bar ends in recesses within the legs having the form of flat bows in order to join the ends of the legs essentially in configurational aspect and with respect to the transmission of forces. It is the object of the invention to develop the known connecting bar further which is either used as a single bridge or a double bridge so that this bar or this bridge, respectively, can be used in some extent like a substitute element as a medical means for healing purposes in case of hoof sicknesses. The edge of the connecting bar located in the direction of the closed end of the hoof pad forms a wedge-like upper extension of the connecting bar covering mainly the beam of the hoof forming with said edge a unitary entirety, and that the oppositely located edge of the connecting bar directed to the aperture of the hoof pad provides a conical lower extension of the connecting bar.

The invention concerns a horseshoe-like hoof pad of plastic material provided with a lower the underground contacting surface having profile elements. Both legs of the hoof pad can be connected for elongation of the distance of the legs to the size of the hoof by at least one separate snug fit piece-like connecting bar of plastic material. This connecting bar is engageable with the legs within the area of their ends in order to extend or contract them. The connecting bar which is also named bridge is one layered configured (single bridge) or multiple layered configured (double bridge) and fits with its lateral bar ends in recesses within the legs having the form of flat bows in order to join the ends of the legs essentially in configurational aspect and with respect to the transmission of forces.

Hoof pads of this kind are for instance known from the German Utility Model No. 201 09 470 as well as from the published European Patent Application 00109538.9. In these cases, too, the connection of the ends of the legs of the hoof pad is gained by means of connecting bars in form of a snug fit piece which can be inserted into recesses within the ends of the legs having the form of flat lateral bows.

The use of those snug fit piece connecting bars results in a relatively simple accomodation of the size of the hoof pad to different sizes of the hoof and especially to different positions of the so-called white line of the hoof which is solely suited for the reception of hoof nails or screws to fasten the hoof pad. The known connecting bars bridging the ends of the legs of the hoof and being able to become tightly connected to them can sufficiently protect the bottom of the beam of the hoof and can also in a limited way provide an improved circulation of blood within the beam and thus of the entire hoof and provide moreover a supporting surface for the hoof bottom which is especially advantageous for horses having problems with tendons and hoof diseases.

It is therefore the object of the invention to develop the known connecting bar further which is either used as a single bridge or a double bridge so that this bar or this bridge, respectively, can be used in some extent like a substitute element as a medical means for healing purposes in case of hoof sicknesses. Thus health and efficiency of legs or hoofs, respectively, of the horses are reinstalled and under special consideration of the natural hoof function and the anatomic configuration of the horse foot as well as the weight support and the weight dispersion relatively quick and surprising healing successes are gained. After the end of the healing process this substitute element which can also be called “healing bridge” may either be exchanged together with the entire hoof pad or separately thereof or may be, respectively, substituted by a new hoof pad provided with a “normal” bridge. The substitute element should thus have the function of an auxiliary equipment.

The solution of this subject is characterized therein that the edge of the connecting bar located in the direction of the closed end of the hoof pad forms a wedge-like upper extension of the connecting bar or “bridge”, respectively, mainly covering the beam of the hoof and forms with the hoof pad a unitary entirety and that the opposite edge of the connecting bar or bridge, respectively, directed to the aperture of the hoof pad provides a conical lower extension of the connecting bar so that the connectig bar can be used as a medical means for healing of hoof deseases because of covering of the beam and because of its elastical characteristics.

By this configuration of the connecting bar provided with upper and lower extensions the bar will not only be stabilized because of its greater mass but is also massageing the beam area of the hoof because of its elastic behaviour so that the circulation of the blood is improved and thus the healing process expedited. Moreover, the free uncovered surface of the pad is essentially deminished so that the hoof bottom and the beam are better protected against influences from the underground, for instance influences resulting from stones and rocks.

Advantageous embodiments are characterized in the subclaims.

The invention can be more clearly explained on the basis of embodiments shown in the drawings. In the drawings are:

FIG. 1 a bottom view of the hoof pad provided with an embodiment of the exchangeable connecting bar or bridge, respectively, also called healing bridge,

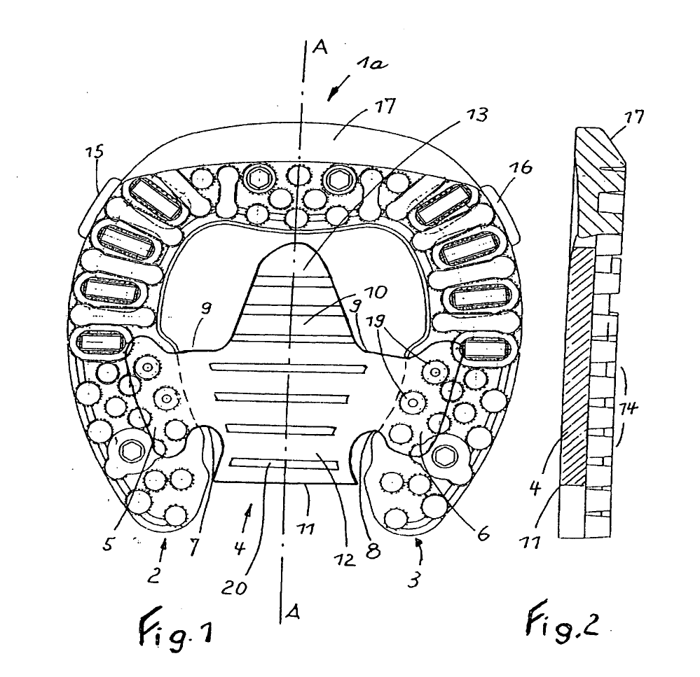

FIG. 2 a lateral view of the hoof pad of FIG. 1 cut along the centerline A-A,

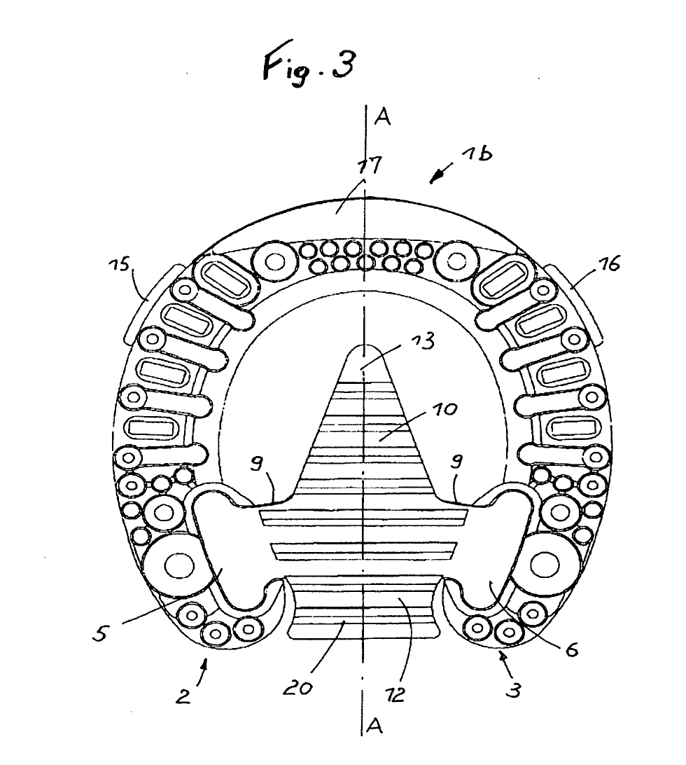

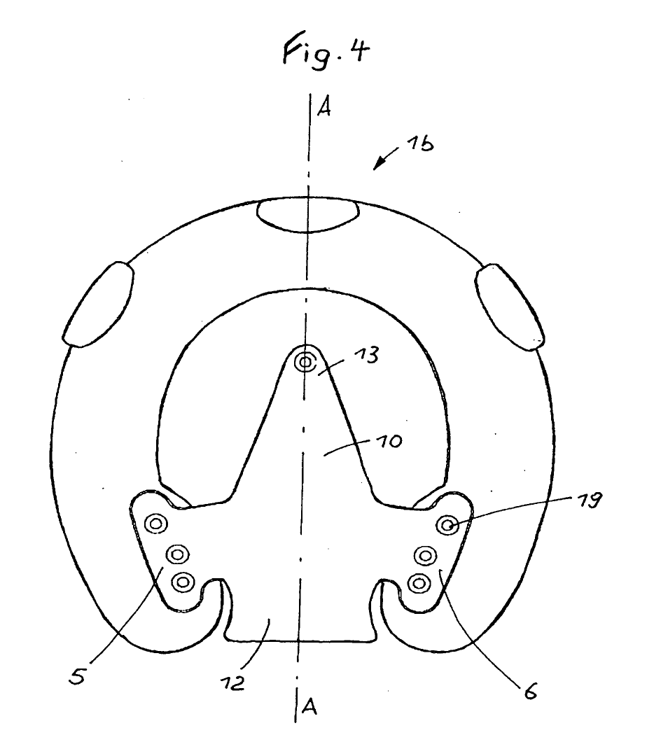

FIG. 3 a bottom view according FIG. 1 of another embodiment of the hoof pad provided with another embodiment of the connecting bar or healing bridge, respectively, and

FIG. 4 a plan view of the hoof pad of FIG. 3.

The horseshoe-like hoof pad 1a as shown in FIGS. 1 and 2 is comprised of plastic material and is provided with a ground surface having profile bodies 14. The two legs 2, 3 of the hoof pad are connected by a separate snug fit piece-like connecting bar 4, which can be called bridge, comprising also of plastic material and enganging the legs 2, 3 in the area of their ends so that it expands or contracts the legs in order to adapt the hoof pad in a certain to the size of the hoof The connecting bar 4 is configured either as a one layered or multi layered element so that a single bridge or a double bride is provided, and it fits with its lateral bar ends 5, 6 legs in form of flat bows into recesses 7, 8 within the and is fastened therein by screws in order to join the ends of the legs in an essentially configurational fitting and force transmitting manner.

The hoof pads 1a and 1b as shown in FIGS. 1 and 3 corresponds to another essential configurational features. Both are comprised of an exchangeable connecting bar 4 provided with a closed hoof pad end located in direction of the edge 9, and forming a wedge-shaped or pyramide-shaped upper extension 10 covering the beam of the hoof essentially and forming with the hoof pad end a unitary configuration. Moreover, there is an oppositely to the upper extension positioned conical lower extension 12 provided with an edge 11 in the direction of the hoof pad aperture. The upper extension 10 as well as the lower extension 12 of the connecting bar configured as a single bridge or double bridge are formed symmetrically to the center axis A-A of the hoof pad.

The upper extension 10 which at least partly covers the beam of the hoof reacts relatively elastically if the surface of the beam is pressurized insofar as the surface of the beam of a horse provided with such a kind of hoof pad is alternatively put under load and released from load if the horse is going resulting therein that the surface of the beam is massaged to a certain extent and the circulation of blood within this surface is improved. This is the reason why that configuration of the connecting bar or bridge, respectively, has a therapeutical effect on the hoof resulting therein that hoof deseases are healed much more quickly if such a kind of bridges are used than during the use of known bridges, i.e. those ones without upper and/or lower extension 10, 12,

The thus configured connecting bars 4 or bridges, respectively, have thus not only the actual purpose of adopting the hoof pad to different sizes of the hoof but in addition thereto at least the supplemental function of treating the surface of the hoot especially the beam of the hoof This is the reason why such a kind of hoof pad in case of hoof deseases will be replaced entirely by commonly used hoof pads or replaced only with respect to the connecting bars or bridges, respectively, by those ones provided with upper and lower bridge extensions as shown in FIGS. 1. and 3.

The two ends 5, 6 of the connecting bar 4 or bridge, respectively, are fastened to the two legs 2, 3, as shown in FIGS. 1 and 2, by means of screws 19, which however can be released. The form of the outer edges of the extension 10, 12 may be adapted to the form of the inner edges of the legs 2, 3 of the hoof pad. It is also possible, however, to configure them, as shown in the drawings, like a heart, wherein the upper and lower extensions 10, 12 as well as the tip 13 of the upper extension are with respect to their sizes and configurations insofar restricted as they must fit into the space of the hoof surrounded by the hoof pad and must correspond to the required maximum support of the pad on the hoof amd thus to the maximum utilization of the supporting parts, namely beam, bottom and supporting edge. In such a way the requested aim is gained, namely, as already pointed out, to use the connecting bar 4 or bridge, respectively, as well as the means provided essentially for therapeutical purposes such that one can speak in this connection of a kind of “healing bridge”, keeping in mind that by the flexibility of the plastic material from which the connecting bar or bridge, respectively, as well as the extension 10 and 12 are manufactured, the pad is elastically deformed under the weight of the horse and thus is massageing the beam of the hoof so that no permanent pressure and thus also no disbursement of the blood streaming through the beam is caused but in contrast thereto the passing of the blood is increased in order to support healing processes.

The hoof pad 1a of FIG. 1 is provided in a manner known per se with two upstanding pieces 15, 16 and on its head portion with a flat or slanty, respectively, bottom surface 17 which is free of any kind of profile bodies, especially of nap-like profile bodies 14. Moreover, this surface is provided in the direction of the ends of the legs 2, 3 with an increasing, wedge-like cross-section, as shown in FIG. 2. The upper side of the connecting piece corresponding to the lower side of the hoof pad 1a provided with those naps 14 as shown in FIG. 1 is provided with channels and/or grooves 20 extending generally rectangularly to the center line A-A of the hoof pad and improving possibly the operation qualities of the pad dependent on the conditions of use.

1. Horseshoe-like hoof pad of plastic material provided with a lower the underground contacting surface having profile elements, both legs of the hoof pad can be connected for extending the distance of the legs to the size of the hoof by at least one separate snug fit piece like connecting bar of plastic material, which connecting bar is engageable with the legs within the area of their ends extend or contract them, and is also named bridge having a one layered configuration (single bridge) or a multiple layered configuration (double bridge) and fits with its lateral bar ends in recesses within the legs having the form of flat bows in order to join the ends of the legs essentially in configurational aspect and with respect to the transmission of forces, characterized in that the edge (9) of the connecting bar (4) located in the direction of the closed end of the hoof pad forms a wedge-like upper extension (10) of the connecting bar covering mainly the beam of the hoof forming with said edge a unitary entirety, and that the oppositely located edge (11) of the connecting bar (4) directed to the aperture of the hoof pad provides a conical lower extension (12) of the connecting bar.

2. Horseshoe-like hoof pad according to claim 1, characterized in that the upper extension (10) as well as the lower extension (12) of the connecting bar (4) is configured symmetrically to the center axis A of the hoof pad (1).

3. Horseshoe-like hoof pad according to claim 1, characterized in that the thickness of the connecting bar (4) corresponds essentially to the thickness of the hoof pad (1).

4. Horseshoe-like hoof pad according to claim 3, characterized in that the extensions (10, 12) are provided with a thickness corresponding essentially to the thickness of the connecting bar (4).

5. Horseshoe-like hoof pad according to claim 1, characterized in that the connecting bar (4) is comprised of two essentially identical covering parts enclosing at least partly in the range of the ends (5,6) of the bar the two legs (2, 3) of the hoof pad.

6. Horseshoe-like hoof pad according to claim 1, characterized in that the surfaces of the extensions as well as of the connecting bar corresponding to the bottom surface of the hoof pad (1a, 1b) are provided with profile bodies (14).

7. Horseshoe-like hoof pad according to claim 6, characterized in that the profile bodies are comprised of channels and/or grooves (20) extending rectangularly to the middles axis A-A of the hoof pad (1a, 1b).

8. Horseshoe-like hoof pad according to claim 1, characterized in that the configuration of the outer edges of the extensions (10, 12) is adapted to the configuration of the inner edges of the legs (2, 3) of the hoof pad (1).

9. Horseshoe-like hoof pad according to claim 1, characterized in that the extensions (10, 12) together with the connecting bar (4) consist of one portion and that if a connecting piece is used consisting of two superimposed parts, the extensions (10, 12) are also comprised of two essentially covering, superimposed surface parts.

10. Horseshoe-like hoof pad according to claim 9, characterized in that the essentially covering surface parts are connected together by screws.

11. Horseshoe-like hoof pad according to claim 9, characterized in that the essentially covering surface parts are connected to the legs (2, 3) of the hoof pad (1) by screws.

12. Horseshoe-like hoof pad according to claim 1, characterized in that the bride (4) is together with its extensions (10, 12) provided with a heart-like circumference.

13. Horseshoe-like hoof pad according to claim 12, characterized in that the upper extension (10) has the configuration of a cone and the lower extension (12) has the configuration of a truncated cone.
